(19) United States
(12) Patent Application Publication
(10) Pub. No.: US 2002/0135486 A1
(43) Pub. Date: Sep. 26, 2002

(54) Device and procedure for surveillance of the use of a hygiene station

(76) Inventors: Per Brohagen, Molnlycke (SE); Allan Salaker, Vikmanshyttan (SE)

Correspondence Address: Ronald L. Grudziecki, BURNS, DOANE, SWECKER & MATHIS, L.L.P., P.O. Box 1404, Alexandria, VA, 22313-1404, US

(21) Appl. No.: 10/101,704

(22) Filed: Mar. 21, 2002

Related U.S. Application Data
(60) Provisional application No. 60/277,940, filed on Mar. 23, 2001.

(51) Int. Cl. G08B 23/00

(52) U.S. Cl. 340/573.1; 340/540

(57) ABSTRACT

The invention related to a device for surveillance of the use of a hygiene station (1) or a similar establishment for washing of hands by one or more users, which device comprises a first sensor device (4) arranged in connection with said hygiene station (1), for detection of presence and identification of users who are in its vicinity, and also a control unit (6) to which said first sensor device (4) is connected. The invention is characterized in that the control unit (6) is connected to a second sensor device (7) for detection of the use of a drying device (2) arranged for drying after the use of said hygiene station (1), where the control unit (6) is arranged for gathering and storage of information concerning said detection of presence, identification and use of the drying device (2) based on signals from said first sensor device (4) and said second sensor device (7), respectively. The invention also relates to a procedure for such surveillance, and also a drying device intended to be used at such surveillance. The invention offers an enhanced arrangement and procedure for surveillance of the extent to which a number of users uses a hygiene station, for example a washstand (1), for washing of hands.

### TECHNICAL FIELD

The invention relates to a device for surveillance of the use of a hygiene station or a similar establishment for washing of hands by one or more users, which device comprises a first sensor arrangement arranged in connection with said hygiene station, for detection of presence and identification of users who are in its vicinity, and also a control unit to which said first sensor arrangement is connected.

The device also relates to a procedure for surveillance of the use of a hygiene station of a similar establishment for washing of hands by one or more users, comprising detection of presence and identification of one user who is in the vicinity of said hygiene station.

The invention also relates to a drying device for drying in connection with washing of hands and arranged to be used at detection of whether one or several users uses a hygiene station or a similar establishment.

The invention also relates to a procedure for distribution of information from a computer based central unit to an authorized user, comprising reception of information concerning the identity of said authorized user, reception of information concerning an order for the desired information from said authorized user, at which said authorized user communicates with a central unit via a communication system, output from a data base concerning information which corresponds to information that is desired of the authorized user, and also transfer of information to the authorized user via said communication system.

The invention also relates to a procedure for surveillance of the consumption of at least one piece of consumer goods in connection with a hygiene station or a similar establishment.

### BACKGROUND ART

Within business that comprises handling and preparation of provisions there is a risk for spreading of certain infectious matter and contaminations. It has been established that a matter that contributes to such a spreading of contagious matter is that personnel within such business, i.e. for example in the restaurant business, butcheries, school cantinas and similar, do not wash their hand in a sufficient extent and sufficiently frequently. It is a serious problem which is estimated to be the cause of a great amount of cases of illness and deaths all around the world. The problem is also of current interest concerning for example personnel working at hospitals.

In order to lower the risk of such negative consequences of imperfect hand hygiene there are instructions for employees within for example the food industry to wash their hands with certain intervals of time. Washing of hands is for example instructed before one comes into contact with food and after one has been in contact with any substance that might have been contaminated. As an example of such instructions it can be mentioned that the American authority of Food and Drug Administration (FDA) has established rules (“Food Code”) concerning employees in the food industry. In particular, these rules apply to the need for such employees to carefully wash their hands in connection with preparation of food and also in connection with for example visits to the toilet and similar.

In order to solve the abovementioned problem with failing hand hygiene several different devices and methods for surveillance of the personal hygiene of for example employees in the food industry or in the medical care has been proposed earlier. There are, for example, different possible ways to control how often and how long the employees wash their hands, i.e. to control the inclination of a number of persons to use the washing facilities available.

A previously known system that is focused on such surveillance is described in the patent document U.S. Pat. No. 5,793,653. This document shows a surveillance system which is arranged to control whether specific persons wash their hands and, in that case, if such a washing of hands follows a certain predetermined pattern (which for example may prescribe that the person who washes shall flush water during 5 seconds, lather the hands during 20 seconds and then rinse the hands during 5 seconds). The system comprises a control unit with a detection arrangement which is used for controlling the identity of the user. This detection arrangement can be in the shape of a keyboard or a barcode reader with which help the user may state his identity.

The system according to U.S. Pat. No. 5,793,653 is further used for detection of how long time that the user has used a washstand and also for detection of the consumption of soap in connection with the washstand. In such a way surveillance of the use of the washstand is made possible.

It can be established that the system according to U.S. Pat. No. 5,793,653 is afflicted with certain disadvantages. Foremost, it can be mentioned that it is consisting of a relatively large amount of different components that bring an extensive amount of installation work and which demands a relatively large volume in connection with a washstand. The demand of space constitutes a problem, especially in connection with for example the installation of the system in toilets, where the space available often may be strongly limited. A further disadvantage with this system is that the detection of a user's presence demands an active step of the user. Further, the detection of presence concerning the users is made with the help of a keyboard or a barcode reader, which is a kind of detection of presence which demands contact (for example by depression of buttons on a keyboard), which from a hygiene point of view is a disadvantage.

### DISCLOSURE OF INVENTION

A purpose with the invention is to provide an improved system for surveillance of in what degree a number of users uses a washstand or a similar establishment for washing of hands.

This purpose is achieved by means of a device mentioned in the introduction, which characteristics will be evident from the appended claim 1 and which will be characterized in that the control unit is connected to a second sensor device for detection of the use of a drying device arranged for drying after the use of said hygiene station, where the control unit is arranged for gathering and storage of information concerning said detection of presence, identification and use of the drying device based on signals from said first sensor device and said second sensor device respectively.

The abovementioned purpose is also obtained by means of a procedure that is mentioned in the introduction, which characteristics are evident from the appended claim 13 and which is characterized in that it comprises detection of the use of a drying device arranged for drying after the use of said hygiene station, and also gathering and storage of information concerning said detection of presence, identification and use of the drying device.

The abovementioned purpose is also obtained by means of a drying device of a kind mentioned in the introduction, which characteristics are evident from the appended claim 21 and which is characterized in that it comprises a first sensor device for detection and identification of an identification unit intended to be carried by respective user, and a second sensor device for detection of the use of said drying device for drying after the use of said hygiene station, and also a control unit for gathering and storage of information from said first sensor device and said second sensor device respectively.

According to an embodiment said first sensor device, said second sensor device and said control unit are arranged to be integrated into said drying device. This means that the invention enables a highly integrated system with a small volume and a small amount of components, which in its turn admits a simple installation at a low cost.

The first sensor arrangement is preferably arranged to communicate wireless with an identification unit which in turn is intended to be carried by respective user, when an automatic detection of presence and identification of respective user is made. This gives a simple and automatic registration of the data which are connected to the identity of respective identification unit.

The identification unit is preferably of the type which comprises a signalling device, for example a light emitting diode, which can be arranged to indicate for the user when, for example, washing of hands has been accomplished in an acceptable manner. In a corresponding way the identification unit suitably comprises one further signal device, for example a light emitting diode, which then is arranged to indicate for the user that washing not has been carried out within a predetermined period of time. Since the identification unit suitably is carried on the clothes of respective user he receives clear indications on when washing has been made and when it has to be done, respectively.

According to an embodiment the drying device consists of a container for paper. In that way the invention admits a unit integrated in the paper container which comprises the components which are necessary for its function. Said second sensor arrangement can then suitably consist of a detector for detection of the amount of consumed paper in said container.

According to further embodiments, the invention may comprise at least one more sensor arrangement for detection of, for example, the consumption of consumer goods, for example liquid soap which is dispensed from a container. This further embodiment can together with said container be designed to be detached units or can alternatively be integrated with the other above-mentioned components of the drying device. Such further sensor arrangement can also consist of a sensor for detection of the amount of water which is flushed by means of a water tap belonging to the washstand, or a sensor for measuring the length of the period of time during which a user flushes water in the washstand. When the drying device is of the kind which comprises an arrangement for blowing air which is intended to be directed towards the hands of the user during drying, the invention may also comprise a sensor for measuring the period of time during which air is blown over the hands of a user.

According to an embodiment, said control unit is arranged to communicate with a local computer unit for setting some parameters which are used at operation of respective control unit and associated components. One or more such local computer unit is in turn arranged to communicate with a central computer unit which then may be used for by way of example calculations and presentation of the data which has been gathered in connection with respective washstand.

One further purpose of the invention is to provide a procedure for distribution of information to an authorized user, which admits a simple and effective transfer of information and a flexible treatment of said information. This purpose is also achieved by means of a procedure mentioned in the introduction, which characteristics are evident from the appended claim 24 and which is characterized in that said information comprises data related to the extent of the use of a hygiene station or a similar establishment, where said information is gathered via at least one sensor for generation of signals which indicate the degree of use of the hygiene station and which are fed into said central unit.

A further purpose of the invention is to provide an improved procedure for surveillance of the consumption of at least one piece of consumer goods in connection with a hygiene station, which particularly creates the conditions for a precise and continuous follow-up of said consumption, which contributes to effective routines for by way of example stock-keeping and refilling of said consumer goods. This purpose is achieved with a procedure mentioned in the introduction, which characteristics are evident from the appended claim 27 and which comprises collecting signals from at lest one sensor concerning the consumption of said piece of consumer goods, transferring said signals to a computer based control unit, and also generating signals concerning ordering and/or refilling of said consumer goods at the hygiene station, depending on said collected signals from said sensor.

In this context the general term “drying device” is used to describe a device which is arranged for drying the hands of a user after washing. This drying device can consist of a container for paper where the user tears a piece of paper and dries his hands. The consumed paper is then thrown into a wastepaper basket or something similar. The drying device may alternatively consist of a container for feeding of a washable and reusable towel which is fed gradually to the succeeding users. The drying device may alternatively consist of the kind which comprises a blowing device for air intended to be directed towards the hands of the user to dry these. According to one more alternative the drying device may consist of a roll system for drying paper, where paper is fed from an upper roll with fresh, unused paper, via a space where the hands may be dried, and to a lower collecting roll for used paper.

Further, the designation “hygiene station” is used in this context to designate an establishment intended to be used by a number of users for personal cleaning, mainly concerning washing of hands. Such a hygiene station is not limited to solely consist of conventional washstands with a washbasin and a water tap, but may also consist of the kind of establishment where a user can dispense a hand cleaning agent of the alkogel kind from a container, that is a gelatinous substance containing among other things alcohol, where cleaning and drying takes place without the need of water to rinse the hands and where a water tap thus will not be used.

### BRIEF DESCRIPTION OF DRAWINGS

The invention will in the following be described more in detail referring to the figures shown on the enclosed drawings in which:

FIG. 1 is a perspective view showing a device according to the present invention,

FIG. 2 is a schematic figure showing the components that are part of the invention and showing how these cooperate, and

FIG. 3 is a schematic figure describing components for detection of presence which can be used according to the invention.

### MODES FOR CARRYING OUT THE INVENTION

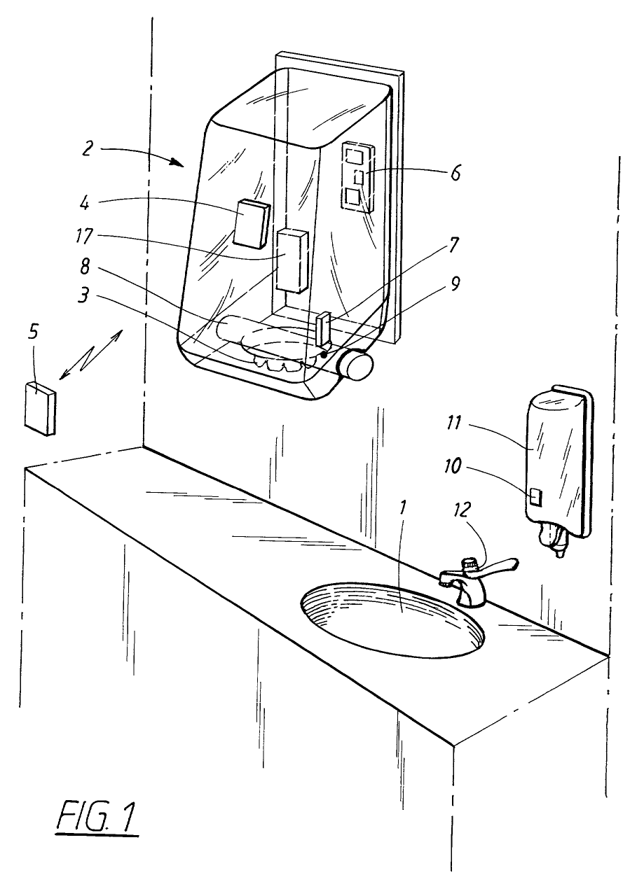

In FIG. 1 a perspective view of a device according to the present invention is shown. According to a first embodiment, the device for surveillance of whether one or more users are using a washstand 1 or a corresponding establishment intended for washing of hands is used. The device is preferably, but not exclusively, intended to be used by users consisting of employed personnel at companies in the food business, in the medical care, in the restaurant business or in other lines of business where the demands for cleanliness and good hand hygiene are high.

Thus the device according to FIG. 1 is arranged in connection with a washstand 1 and comprises a drying device which according to the embodiment consists of a container 2 for paper, more precisely for a (not shown) paper roll which free end is intended to be within reach for the user via a lower opening 3 in the paper container 2. Alternatively, the end of the paper roll can be within reach via an opening in some other part of the paper container than its lower part.

According to what will be explained in detailed below, the paper container 2 comprises a number of components which are arranged for surveillance of the use of the washstand 1 for washing of hands of a number of users. More precisely the invention is arranged for gathering, storage and treatment of information concerning the possible presence of a user in a close vicinity of the washstand 1 and also, in the case where such a presence has been established, identification of the user. For this purpose the paper container 2 comprises a first sensor device 4 in the form of a detector of presence, which suitably is of the kind that works with infrared radiation. The detector of presence 4 then comprises a transmitting and receiving unit for generation of infrared radiation within a certain limited area in connection to the washstand 1. Suitably, this area may be constituted by a zone which is formed within a certain radius counting from the washstand. This radius may suitably be of the order of 0.5-1.0 m counting from the position of the washstand, and is determined after the current application and in dependence of the space available in connection with the washstand 1.

The detector of presence 4 is arranged to cooperate with a number of identification units, of which an identification unit 5 is shown in FIG. 1. Further, the detector of presence 4 is arranged on the paper container 2, suitably on or inside its front. The identification unit 5 is in turn preferably tied to a certain user and is intended to be carried on the clothing of respective user. Every identification unit has a unique identity and then comprises predetermined, unique information which is used for its identification. This information may also be tied to the identity of the person which is expected to carry the identification unit 5 concerned when needed.

According to what will be described in detail below, the sensor of presence 4 is arranged in a way that enables a signal corresponding to the identity of the identification unit 5 to be transmitted to the detector of presence 4 when it has been determined that the user is within the current zone of detection. This signal is transmitted to a control unit 6 connected to the detector of presence 4. The control unit 6 is also arranged inside the paper container 2, and then suitably in its rear part. The connection between the detector of presence 4 and the control unit 6 is suitably made via a (not shown) electrical wire.

There is also a second sensor device 7 connected to the control unit 6, this one also via a (not shown) electrical connection of a suitable kind. The second sensor device 7 is arranged to emit a signal which corresponds to the extent at which the user dries the hands in connection with the washing of hands. According to the embodiment, the second sensor device 7 is of the kind that is used for detection of movement of a rotating feeding component 8 for the paper in the paper holder 2. In this contexts can be noted that the drying device 2 comprises not shown components in the form of rolls etc. around which the paper is fed.

According the embodiment shown in the figures it is suitable to use a sensor device in the form of a so called Hall-sensor which is arranged in connection with the rotating feeding component 8. According to the embodiment the feeding component 8 is consisting of a rotating knife which at one of its end parts comprises a small permanent magnet 9. Each turn that the feeding component 8 rotates corresponds to the feeding of a predetermined sheet of paper from the paper container 2. During this lapse the permanent magnet 9 will pass the Hall-sensor 7 a number of times, which thus corresponds to the number of turns of the feeding component 8. In a way that is previously known, the Hall-sensor 7 will generate a pulse for every turn that the feeding component 8 rotates. This means that a signal that corresponds to the consumption of paper will be generated and delivered to the control unit 6, which then stores data concerning this information.

The invention is not limited to the implementation with the above mentioned Hall-sensor 7, but may be realized with other sensors, for example inductive or capacitive sensors which then are arranged to detect the rotation of the feeding component 8. Both inductive and capacitive sensor are in themselves previously known and will therefore not be described in detail here. A principle behind the invention is that a suitable sensor device is used to supply a measure of to which extent the drying device 2 is used. By means of the abovementioned Hall-sensor 7, this is achieved by detecting the rotation of the feeding component 8, which gives a measure of the consumption of paper.

The invention is not limited to be used with paper containers of the kind that is shown in FIG. 1. Containers for both standing and lying rolls may be used within the scope of the invention. Further, a paper container of the kind which is used for lying folded sheets of paper or textile, that is in the form of towels which are fed one an one may be used. The opening for feeding of paper may also be supplied with a tearing edge.

Besides the detector of presence 4 and the Hall-sensor 7, the invention—according to alternative embodiments—may be arranged with more sensors for detecting further signals that constitutes measures at which extent a user uses the washstand. For example a further sensor device 10 may be used to detect the consumption of an article of consumption in the form of a hand cleaning agent. Suitably this is constituted by liquid soap. This further sensor arrangement 10 is then suitably built-in to a container 11 for liquid soap and also connected to the control unit via a further (not shown) electrical connection. More in detail the container 11 is closed with a valve device which may be opened for dispensing soap when the user pushes a feeding button (not shown). Above mentioned third sensor device 10 preferably consists of a micro switch which is arranged in connection with this feeding button. Every push on the feeding button activates the micro switch, which in turn generates a signal which is transmitted to the control unit 6. The third sensor 10 is for this purpose connected to the control unit 6 via a connection which may consist of an electrical wire but alternatively may consist of a link for infrared radiation of mainly the same kind as the connection between the sensor of presence 4 and the identification unit 5. According to a further embodiment, the whole soap container 11 with its sensor 10 is integrated into the paper container 2, as well as the other abovementioned components.

Apart from liquid soap, the invention may be arranged in connection with containers for other consumer goods, for example alcohol based gels, skin creams, disinfectants and similar.

The invention is not limited to be used with sensor for detection of consumer goods for hand cleaning, as for example liquid soap, but the spirit of the invention may be realized with a system that solely comprises a sensor for detection of presence and a sensor for detection of at which extent the drying device 2 is used. An advantage with the invention is then that it may be implemented in such a way that all the components necessary for the detection may be accommodated in the paper container 2. In this way it constitutes an integrated and compact unit with a small volume and simple design that comprises all the functions which are necessary for the detection according to the invention. This gives in turn advantages concerning installation, cost, maintenance and need for space.

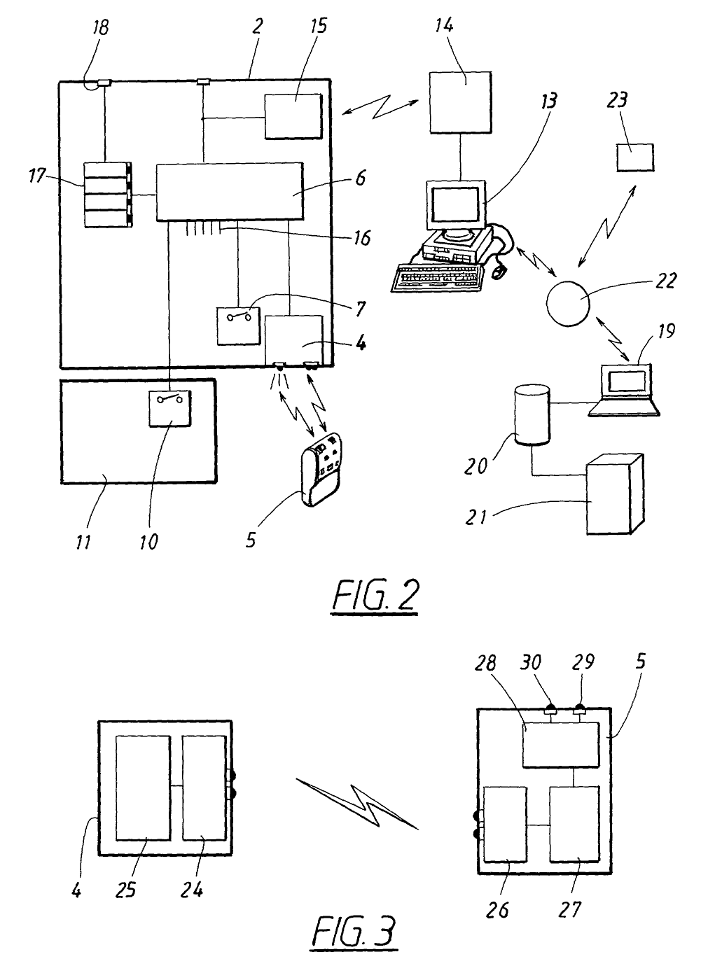

A purpose with the control unit 6 is to gather and store measured results based on signals from the sensor devices 4, 7, and also to transfer data with reference to the signals to a local computer unit, which is not disclosed in FIG. 1 but will now be described with reference to FIG. 2 which is a schematic picture that shows the components that are part of the invention. In FIG. 2 the local computer is shown with the reference number 13. This computer 13 suitably consists of a standard computer of the PC type which is connected to the above-mentioned control unit 6 via a first communication unit 14. For transfer of information, the control unit 6 is connected to a second communication unit 15 which suitably is arranged in direct connection with the control unit 6 (but which, however, is not shown separately in FIG. 1).

From FIG. 2 it is also evident that the control unit 6 is equipped with a suitable number, for example 5-10, of signal inputs 16 for connecting different sensor devices. The control unit 6 is suitably designed with a relatively large number of signal inputs, so that every specific control unit may be adapted to a certain application and permits connection of a different number of sensors. Thus a specific control unit may be used for different applications with just the sensor arrangements which are estimated to be suitable. The system thus constitutes a flexible solution which may be adapted to the current application.

In order to feed current to the control unit 6, the system comprises a current supply unit 17 which suitably consists of a transformer which is connected to mains voltage (230 VAC) via an outer connection 18. The current supply unit 17 may be built into the paper container 2 as well as all the other components, but may also be placed as an external component. As an alternative the mains voltage connection may be excluded and a built-in battery packet may be used as a current supply unit instead.

According to what has been mentioned above, the control unit 6 may be connected to a third sensor arrangement 10 for detection of a fed amount of hand cleaning agent, suitably soap, from a container 11. The container 11 and the sensor arrangement 10 may be integrated into the paper container 2 or alternatively constitute a unit standing alone.

The local computer 13 is arranged to gather and administrate data concerning the events which have been recorded with the help of the sensor device. For this purpose the local computer 13 is equipped with a memory unit for storage of the current information in a conventional manner. The principles of such a gathering and storing of generated data from sensors to a computer memory are known in themselves, and will not be described in detail here.

The local computer 13 is suitably arranged with a computer program of a data base type which then is adapted to admit gathering of data and presentation of the gathered data. Except for the identity of a certain identification unit 5 which is detected during cleaning, data is gathered concerning the time at which the cleaning starts, in other words the point of time at which a user enters the detection zone. For example data is also gathered for points of time at which signals from the abovementioned second sensor device 7 (suitably a Hall-sensor) are received. The computer program is also arranged to admit setting of the parameters related to different demands in connection with the current detection of the use of the washstand 1. For example such parameters may consist of the maximum allowed time that may be allowed to pass without respective user washing the hands. From the local computer 13 such parameters that concerns the transfer of information from the control unit 6 to the local computer 13 are also controlled. This last mentioned transfer is suitably conducted by letting the local computer 13 initiate a download of data from the control unit 6, where at certain predetermined points of time for example once a day, at which these data then have been gathered the last day. A condition for this procedure is then that the control unit 6 comprises a memory which can be expected to be enough for storing the data concerning the events of the last day.

All information in the local computer 13 may also be transferred to an external computer system 19 which then may be connected to a data base 20 and an external server 21, by means of which the information which has been gathered of the local computer 13 may be stored and treated. The transfer from the local computer 13 to the external computer system 19 may suitably be executed via a network such as the Internet 22. Such a system may be suitable when a large amount of local computers which in turn are connected to a number of control units (which each one is tied to components for the abovementioned detection of presence and detection of the use of the drying device) in a network are intended to be connected to one and the same external computer system 19. This may be the case when for example a company in the form of a chain of restaurants equips all their restaurants with the device according to the invention, where the local computers then transfer their data to the external computer unit, which then may be available for a central surveillance function in the company. In such a case these data may be used for analysis and treatment according to predetermined guidelines. Such collected data may for example be used to determine which restaurants that show good respective bad results concerning the hand hygiene of the personnel. Further, collecting information of factors that effect the extent to which personnel uses the cleaning establishments and factors that creates risk for bad hand hygiene is admitted.

All stored information concerning events in the form of the cleaning time of the personnel, use of a drying device and possible further parameters may thus be used to verify whether stipulated demands for cleanliness—which may be demands that has been stipulated by the company itself or demands that have been stipulated by the authorities or in the shape of legal demands—are fulfilled by the current company.

Even though it is not disclosed in detail in FIG. 2, the local computer 13 may thus be connected to several stations which each one is built around a paper container with sensors and a control unit. Each one of these stations is then placed in connection with each one's own hygiene station, according to the principles which have been described above. The local computer 13 then forms a network together with the hygiene stations, where information is loaded from respective control unit to the local computer 13 with predetermined time intervals.

For the case where the database 20 and the server 21 belongs to a private company, it is reasonable to assume that the collected and treated information is unavailable for outsiders. The invention may however be used in such a way that the company could admit access to this information for certain authorized users (for example customers, cooperation partners, subcontractors, internal controllers and similar authorized users. Such a further authorized user is indicated schematically with the reference number 23 in FIG. 2. This user 23 may be granted access to the information in the external computer system 19 by connecting to the Internet 22, where the actual connection to the external computer system 19 is admitted in the usual manner by means of a password.

Thus the invention admits an efficient means to distribute information from, by way of example, a company to an authorized user. When the external central computer unit 19 has received information concerning the identity of said user and also information concerning which information the user needs, suitably designed reports and similar may be fed to the user via the Internet. This information then concerns the extent of use of a washstand 1 and has then been gathered via the above mentioned sensor devices 4, 7, 10.

In the following a lapse will be described when a user uses the washstand 1, where the present invention is used. When a user wishes to wash the hands he or she stands at the washstand 1. As soon as the user is within the detection zone this will be detected by the detector of presence 4, which then cooperates with the identification unit 5 that the user carries on his clothes. According to what has been mentioned above, the detector of presence 4 suitably communicates with the identification unit 5 via infrared radiation. According to what is evident from FIG. 3, which schematically shows a detector of presence 4 and an identification unit 5, the detector of presence 4 comprises a transmitter and receiver unit 24 and a decoder 25. Further, the identification unit 5 comprises a transmitter and a receiver unit 26, a decoder 27 and also a control unit 28. The identification unit 5 suitably also comprises a current source in the form of a (not shown) battery. Such a battery may also be rechargeable. The two decoder units 25, 27 are used to transform the digital information which is used by the control unit 6, the detector of presence 4 and the identification unit 5 to signals which are suitable to transfer via infrared radiation. It may then be established that the detector of presence 4 emits infrared radiation via its transmitter and receiver unit 24. When an identification unit 5 is within the current detection zone, its receiver circuits will detect the transmitted infrared radiation. This means in turn that it sends information concerning its identity as a response, which information then is detected by the detector of presence 4 and stored in the control unit 6. Besides information about the identity, the point of time at which the identification unit 5—and thus also the user—entered the detection zone at the washstand 1 is registered. When the control unit 6 has established the fact the user has fulfilled certain criteria which are predetermined, for example that the user has been within the detection zone a predetermined period of time which for example may be of the order of 5-15 seconds, which has used the drying device 2 in a determined manner (for example used a certain amount of paper), a signalling device is activated, suitably in the form of a green light emitting diode 29, which is arranged on the identification unit 5. This is a signal intended for the user which confirms that he or she has been at the washstand 1 and thus may be supposed to have washed the hands during a sufficient period of time. In other words the light emitting diode 29 is used to indicate for the user that washing has been performed in an acceptable manner.

The criteria which are intended to correspond to an acceptable washing may vary, and are suitably adapted for the current application of the invention. For example, within certain lines of business or for certain categories of personnel there may be especially strict demands concerning to which extent the washstand is considered to be used for washing the hands. For example these criteria may then comprise demands for the user to be within the detection range a relatively long time at the same time as a certain amount of soap shall be dispensed and a certain amount of water shall be flushed. The invention is particularly suitable to be used for the cases where different categories or personnel use one and the same hygiene station, and where different demands concerning washing of hands are stipulated for respective category of personnel.

Except for a detection of when the washing began (i.e., when the user entered the detection zone) the identity of the identification unit 5 and the point of time at which the washing was finished is thus also registered. This latter piece of information is obtained by the point of time when the identification unit no longer is within the detection zone.

After washing, it is fair to assume that the user will tear off a piece of paper from the paper container 2. According to what has been described above, this will then be detected with the help of the Hall-sensor 7 and registered in the control unit 6. More precisely, information concerning how much paper that has been used is registered, and also the point of time for the detection, with the help of the Hall-sensor 7.

When one more sensor is used for, by way of example, detection of the amount of soap that is consumed, information on which amount of soap that has been dispensed is also registered, and also the point of time for the dispensing of soap.

Since the control unit 6 comprises stored information concerning the point of time when the user has washed the hands, information concerning such a point of time may also be transferred to the identification unit 5 when the washing is finished. This means that the identification unit 5 may be equipped with a reminder function, which then works in the following manner. The control unit 28 of the identification unit 5 comprises a clock which is reset at the point of time when a washing has been finished. When a certain period of time has passed from said point of time it may be assumed to be suitable for the user to wash the hands again. For personnel that works with food said period of time may be of the size 30-60 minutes. When this period of time has passed without any washing taking place one more signalling device 30 is thus activated on the identification unit 5. This further signalling device 30 is then suitably consisting of a red light-emitting diode, which preferably can be controlled to twinkle after the passing of this period of time. This will then indicate for the user that a washing has not been performed within a predetermined period of time and that he or she as soon as possible must wash the hands. This signal device 30 may be used as an indicator even for certain other cases where respective user not has used the washstand 1 according to stipulated criterions, for example if the user has been within the detection area a certain time without using the drying device 2.

The period of time which shall be used may be programmed via the local computer 13 (see FIG. 2). As mentioned above, the criterions which are defined to state that washing has been conducted in an acceptable manner can be different depending on, for example, the tasks of respective user. Information concerning the period of time can then be transferred to the identification unit 5 via the control unit 6 and the detector of presence 4.

It is thus a fundamental principle that the invention comprises a first sensor device 4 for detection of presence and identification of a user with the intention to wash the hands and who, thus, is in the vicinity of the washstand 1. The invention is also based on the fact that it comprises a second sensor device 7 for detection of whether a user dries that hands, and to which extent this takes place. These two sensor devices 4, 7 are together with the control unit 6 (and its communication unit 14) preferably built into the paper container 2. In this way the paper container 2 constitutes an integrated unit which is compact and cost efficient and which moreover gives the advantages mentioned above. The system can also be built with cheap components of standard type, which also contributes to a low total cost.

The hygiene station which is used in accordance with the invention may consist of a conventional washstand with a washbasin and a water tap, but may also consist of the kind where a user may feed a hand cleaning agent from a container which does not demand rinsing with water. For example a hand cleaning agent of the kind alkogel may be used, with other words a gelatinous substance containing among other things alcohol, where the drying of the hands takes place as air drying and thus a water tap is not needed.

The communication between the sensors being a part of the system and the local computer may be implemented via wire or wireless. For the case where a large amount of stations with control units are used for transferring data to one single local computer it is advantageous with radio transfer. For normal application it is then possible with a distance between respective control unit and the local computer up to about 100 m, depending on the environment, possible presence of walls and buildings etc. As an alternative to radio transfer between respective control unit and the local computer, these may connected via conventional electrical wires. When radio transfer is to be used in spite of the fact that the distance between the respective control unit and the local computer is relatively long, relay stations with slave transmitters may be used. For the case that the invention is used in establishments such as for example hospitals where existing wires are installed for transfer of signals, the transfer between respective control unit and the local computer is implemented in such an existing wire.

The invention is not limited to the embodiments described above, but may be varied within the scope of the appended claims. For example, the drying device which is used for drying of the hands may consist of a paper container. However, the invention is not limited to this, but the drying device may alternatively consist of a container for a washable and exchangeable towel or according to a further alternative of the kind which comprises a blowing device for air which is intended to be directed towards the hands of the user for drying the hands.

One further sensor device which alternatively may be used for detection of the use of the washstand 1 is a sensor for detection of water consumption, more precisely detection of the amount of water which is flushed through one of the water taps belonging to the washstand (see FIG. 1). This fourth sensor device is connected to the control unit 6 just as all the other, via one (not shown) electrical connection. One further sensor function for detection of the time during which water is flushed through the water tap 12 may also be used.

The detector of presence may suitably be of the kind which works with infrared radiation. Alternatively the invention may be used with a detector of presence which works with radio transfer. In such a case the respective user uses an identification unit in the form of a radio transponder cooperating with a detector of presence, which in turn comprises a transmitting unit and a receiving unit. The radio transponder may be active or passive. For the case where the transponder is passive, its power is transmitted from the transmitter unit, via inductive coupling, and can by this transfer of power transmit information about its identity to the receiver unit in the detector of presence. For the case where the transponder is active, it comprises its own power source for transmitting a radio signal indicating its identity, which signal then may be detected by the receiver unit.

When the drying device consists of a paper container 2 the invention admits, with the help of the Hall-sensor 7, a detection of the consumption of paper in the paper container 2. This information may be used in connection with stock keeping of paper intended for the paper container 2, more precisely for a continuous surveillance and transfer of information to the local computer 13, and also whenever applicable to the external computer system 19, concerning the paper consumption. In a corresponding manner a continuous surveillance of the consumption of other consumer goods, for example soap or other cleaning agents, or for example toilet paper, can take place with the help of corresponding sensors. The information concerning the continuous consumption of such consumer goods may be used to generate signals to the local computer 13 which indicates when new consumer goods must be ordered or refilled at respective hygiene station. Such signals may also be used as an indication for service personnel, for example cleaning personnel of similar, that refill of respective consumer goods must take place. Such an indication may occur at levels for respective consumer goods that may be adjusted either at respective local computer or at the central computer system.

The invention thus admits an enhanced logistic function in connection with distribution, ordering and refilling of the current consumer goods. It may be noted that such a function in principle may be provided without any detection of presence of respective user being made, in other words without using the abovementioned detector of presence 4. Only sensors concerning feeding of respective consumer goods will then be used.

As an alternative for the above mentioned light emitting diodes 29, 30 on the identification unit 5, other signal devices may be used. For example devices which generate sound signals may be used for this purpose.

The invention may be combined with further systems, by way of example for handling consumed paper from the paper container 2. More precisely, the signal from the Hall-sensor 7 which indicates that paper has been fed and used for drying the hands of a user may be used to automatically activate a hatch to a wastepaper basket, into which the user is expected to throw the used paper.

The abovementioned second sensor device 7 does not have to consist of a Hall-sensor, but may alternatively consist of some other form of detector, for example an inductive of capacitive sensor, emitting a signal constituting a measure for the amount of paper which has been fed. Sensors of the kind where a photoelectric cell detects the light from a light emitting diode may also be used to detect the movement of the paper which is used in the drying device 7 and thus supply a measure of the paper consumption.

When the second sensor device consists of a Hall-sensor it may alternatively for the abovementioned embodiment (see FIG. 1) cooperate with a magnet in a rotating axis around which a paper roll is arranged.

1. Device for surveillance of the use of a hygiene station (1) or a similar establishment for washing of hands by one or more users, which device comprises a first sensor device (4) arranged in connection with said hygiene station (1), for detection of presence and identification of users which are in its vicinity, and also a control unit (6) to which said first sensor device (4) is connected, characterized in that the control unit (6) is connected to a second sensor device (7) for detection of the use of a drying device (2) arranged for drying after the use of said hygiene station (1), where the control unit (6) is arranged for gathering and storage of information concerning said detection of presence, identification and use of the drying device (2) based on signals from said first sensor device (4) and said second sensor device (7) respectively.

2. Device according to claim 1, characterized in that said first sensor device (4) said second sensor device (7) and said control unit (6) are arranged to be integrated into said drying device (2).

3. Device according to claim 1 or 2, characterized in that said first sensor device (7) is arranged to communicate wirelessly with an identification unit (5) intended to be carried by respective user, for automatic detection of presence and identification of said user.

4. Device according to claim 3, characterized in that said identification unit (5) comprises a signalling device (29) which indicates for the user that the use of the hygiene station (1) has been accomplished in an acceptable manner.

5. Device according to claim 3 or 4, characterized in that said identification unit (5) comprises one more signalling device (30) that indicates for the user that the hygiene station (1) has not been used in accordance with stipulated criteria.

6. Device according to any of the appended claims, characterized in that said drying device (2) consists of a container for material for drying of hands, preferably paper.

7. Device according to claim 6, characterized in that said second sensor device (7) consists of a detector for detection of the amount of consumed paper in said container (2).

8. Device according to claim 7, characterized in that said container (2) comprises a rotating component (8) which rotation corresponds to the amount of fed paper, and that said second sensor device (7) is arranged to detect the rotation of said component (8).

9. Device according to claim 8, characterized in that said second sensor device (7) consists of a Hall-sensor which cooperates with a permanent magnet (9) arranged in said rotating component (8).

10. Device according to any of the appended claims, characterized in that it comprises at least one more sensor device (10) for detection of the consumption of a cleaning agent from a container (11) and/or the amount of water which is flushed from a water tap (12) belonging to the hygiene station (1).

11. Device according to any of the appended claims, characterized in that said control unit (6) is arranged to communicate with a local computer unit (13) for gathering, treatment and storage of data which has been delivered to said control unit (6).

12. Device according to claim 11, characterized in that said local computer unit (13) is connected with an external computer unit (19) for treatment, presentation and distribution of data which has been gathered via said local computer unit (13).

13. Procedure for surveillance of the use of a hygiene station (1) or a similar establishment for washing of hands by one or more users, comprising detection of presence and identification of a user who is in the vicinity of said hygiene station (1), characterized in that the procedure also comprises: detection of the use of a drying device (2) arranged for drying after the use of said hygiene station (1), and gathering and storage of information concerning said detection of presence, identification and use of the drying device (2).

14. Procedure according to claim 13, characterized in that said detection of presence, identification, detection, gathering and storage is performed via sensor arrangements (4, 7) and a control unit (6) which are arranged to be integrated into said drying device (2).

15. Procedure according to claim 13 or 14, characterized in that it comprises communication between a first sensor arrangement (4) and an identification unit (5) intended to be carried by said user, for detection of presence and identification of said user.

16. Procedure according to claim 15, characterized in that it comprises verification via a signalling device (29) on said identification unit (5) that the use of the hygiene station has been accomplished in an acceptable manner.

17. Procedure according to claim 15 or 16, characterized in that it comprises a reminder via one more signalling device (30) on said identification unit (5) that the hygiene station (1) must be used in accordance with stipulated criteria as soon as possible.

18. Procedure according to any of the claims 13-17, characterized in that it comprises detection of the consumption of a cleaning agent from a special container (11) and/or the amount of water which is flushed from a water tap (12) belonging to the hygiene station (1).

19. Procedure according to any of the claims 14-18, characterized in that it comprises communication between said control unit (6) and a local computer unit (13) arranged for control and setting of parameters related to demands concerning the use of said hygiene station (1).

20. Procedure according to claim 19, characterized in that the local computer (13) communicates with an external computer unit (19) for treatment, presentation and distribution of data which has been gathered via said local computer unit (13).

21. Drying device (2) for drying in connection with washing of hands and arranged to be used at detection of whether one or more users uses a hygiene station (1) or similar arrangement, characterized in that it comprises:
a first sensor device (4) for detection and identification of an identification unit (5) intended to be carried by respective user,
a second sensor device (7) for detection of the use of said drying device (2) for drying after the use of said hygiene station (1), and also
a control unit (6) for gathering and storage of information from said first sensor device (4) and said second sensor device (7), respectively.

22. Drying device (2) according to claim 21, characterized in that is consists of a container for material for drying of hands, preferably paper.

23. Drying device (2) according to claim 21 or 22, characterized in that it also comprises one more sensor device (10) for detection of at least one parameter which constitutes a measure of the use of said hygiene station (1).

24. Procedure for distribution of information from a computer based central unit (19) to an authorised user (23), comprising:
reception of information concerning the identity of said authorised user (23),
reception of information concerning the order of desired information from said authorised user (23), where said authorised user (23) communicates with a central unit (19) via a communication system (22),
output from a data base (20) concerning information which corresponds to the desired information of the authorised user, and also
transfer of information to the authorised user (23) via said communication system (22), characterized in that said information comprises data related to the extent of use of a hygiene station (1) or a similar establishment, where said information is gathered via at lest one sensor (4, 7, 10) for generation of signals which indicate the degree of use of the hygiene station (1) and which are fed into said central unit (19).

25. Procedure according to claim 24, characterized in that said sensor (4, 7, 10) is used for gathering information concerning detection of presence and identification of persons who use said hygiene station (1).

26. Procedure according to claim 24 or 25, characterized in that said sensor (4, 7, 10) is used to gather information concerning the use of a drying device (2) arranged for drying after the use of said hygiene station (1).

27. Procedure for surveillance of the consumption of at least one piece of consumer goods in connection with a hygiene station (1) or a similar establishment, characterized in that the procedure comprises:
gathering signals from at least one sensor (7, 10) concerning the consumption of said consumer goods,
transfer of said signals to a computer based control unit (13; 19), and also
generating signals concerning order and/or refill of said consumer goods at the hygiene station (1), in dependence of said gathered signals from said sensor (7, 10).
